(19) United States
(12) Patent Application Publication
(10) Pub. No.: US 2025/0363434 A1
(43) Pub. Date: Nov. 27, 2025

(54) METHOD AND SYSTEM FOR PROVIDING TECHNICAL SERVICE TO AN AGRICULTURAL WORKING MACHINE

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Ray Ochsner, Papillion, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US)

(73) Assignee: CLAAS Omaha Inc., Omaha, NE (US)

(21) Appl. No.: 19/294,170

(22) Filed: Aug. 7, 2025

Related U.S. Application Data
(63) Continuation of application No. PCT/IB2023/061301, filed on Nov. 9, 2023.

(30) Foreign Application Priority Data
Feb. 9, 2023 (DE) 10 2023 103 208.9

(51) Int. Cl. G06Q 10/0631; G06Q 10/047; G06Q 10/20; G06Q 50/02

(52) U.S. Cl. CPC G06Q 10/06315; G06Q 10/047; G06Q 10/20; G06Q 50/02

(57) ABSTRACT

A method and system for providing technical service to an agricultural working machine. A digital service module of a server, configured to coordinate the technical service, may receive a request for service. The request for service may include at least one part and at least one service needed to fix the problem of the agricultural working machine. The digital service module is divided into a plurality of subsystems and follow a multi-target optimization strategy during planning and implementing the service events.

### CROSS REFERENCE TO RELATED APPLICATIONS

This application is a bypass continuation and claims priority to PCT Application No. PCT/IB2023/061301 (published as WO/2024/165902) filed on Nov. 8, 2023, which claims priority to German Patent Application No. 10 2023 103 208.9 filed Feb. 9, 2023, the entire disclosure of both of which are hereby incorporated by reference herein. This application is also related to U.S. application Ser. No. ______ (attorney docket no. 15191-24026A (P05769/8)), U.S. application Ser. No. ______ (attorney docket no. 15191-24027A (P05770/8)), U.S. application No. (attorney docket no. 15191-24028A (P05771/8)), U.S. application Ser. No. ______ (attorney docket no. 15191-24029A (P05772/8)), U.S. application Ser. No. ______ (attorney docket no. 15191-24030A (P05773/8)), U.S. application Ser. No. ______ (attorney docket no. 15191-24031A (P05774/8)), and US application Ser. No. ______ (attorney docket no. 15191-24032A (P05775/8)), each of which are incorporated by reference herein in their entirety.

### TECHNICAL FIELD

The present invention relates to a method and system for providing a technical service to an agricultural working machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural working machines regularly need technical service, including repairs, changes of damaged and worn parts and upgrades. This technical service is often done at dedicated servicing locations. A customer owning an agricultural working machine in need of such a service then has to move the agricultural working machine to the servicing location. A service technician at the servicing location locates a technical problem, orders spare parts to fix the problem and provides the needed services to fix the problem. Afterwards, the customer may pick up the agricultural working machine.

Technical problems of agricultural working machines often occur during use and lead to a downtime of the agricultural working machine. Downtime for agricultural working machines may have significant negative impacts on farmers and agricultural operations. When a machine is unable to perform its intended tasks, it may result in decreased productivity, lost revenue, and increased operating costs. In some cases, downtime may also lead to missed deadlines for planting or harvesting crops, which may result in reduced yields and lower quality produce. Furthermore, prolonged downtime may result in additional wear and tear on the machine, which may further increase the likelihood of future breakdowns and reduce the lifespan of the equipment. Therefore, minimizing downtime is crucial for maintaining the efficient and profitable operation of agricultural businesses.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an overview of the disclosed method in use.

FIG. 2 illustrates an overview of the components assigned to the disclosed method.

FIG. 3 illustrates an overview of the flow of data between the components of FIG. 2.

### DETAILED DESCRIPTION

As discussed in the background, downtime for agricultural working machines may have significant negative impacts. In this regard, it may be a challenge to improve the situation, as the agricultural processes, that are to be performed by the agricultural working machines in question, often impose a time pressure onto repair works, which time pressure is often dynamic, unpredictable, and potentially different for each and any agricultural process with its individual and unique environment.

Thus, in one or some embodiments, a method and system are disclosed for the technical services of agricultural working machines to be reorganized such that service technicians with service vehicles are loaded with the right tooling and the needed parts to perform the services in a synchronized manner in order to execute the service event directly at the agricultural machine in the field. The parts may arrive at the customer's location just-in-time or a meeting between the part runners and the service vehicles may be arranged. This basic concept may allow executing a service in a single run at the location that the agricultural working machine currently is at or will be at the time of the service.

In one or some embodiments, the above orchestration of the respective entities may be managed automatically by a digital service model. In one or some embodiments, the digital service module may improve, such as optimize, the management in a highly individualized or tailored manner (as opposed to a standard manner), which may increase the complexity of the management process. To reduce complexity, the digital service module is structured into a central management system and one or more subsystems such as any one, any combination, or all of: a route management system; a spare parts management system; and a technician management system.

To bring the necessary flexibility into the digital service module, the management of the digital service module may be based on an optimization strategy, which may comprise a multi-target optimization strategy with a number of weighted optimization criteria.

In one or some embodiments, a focus is on time and/or quality. Regarding the aspect of time, it may be crucial to keep time schedules, such as to perform the technical service in an expected, mostly short time frame. Regarding the aspect of quality, it may be crucial to guarantee at least a predetermined quality level. In one or some embodiments, the expression “quality level” means, for example, that the service may be performed with different levels of durability. A defect belt, for example, may be exchanged with a new belt, which may correspond to a maximum quality level, or may be provisionally repaired by using a special adhesive, which may correspond to a lower quality level in the above noted sense.

In one or some embodiments, one, some or all of those aspects may be weighted according to the optimization strategy, as noted above.

The resulting structure working with a specialized, particularly flexible approach to optimization, may be enormously effective, even with agricultural process changing during the implementation of the technical service.

In detail, a method is disclosed for providing technical service to an agricultural working machine, in which the agricultural working machine is being operated within an agricultural process by a customer. A digital service module of a server, configured to coordinate the technical service, may receive a request for service at least partly during performing the agricultural process (e.g., at least partly while the agricultural process is being performed, such as in preparation for the agricultural process, while performing the agricultural process, or after the agricultural process is performed in winding down performing the agricultural process). The request for service may include a problem description regarding a technical problem of the agricultural working machine. The server may comprises a database, wherein the database may include or have stored therein any one, any combination, or all of: information about the agricultural process; location of the agricultural working machine; locations of spare part(s) for the agricultural working machine; information about transport device(s) (such as part runners for the transport of parts); information about service vehicle(s) comprising tools for servicing the agricultural working machine; and information about service technician(s),

In one or some embodiments, the spare part(s) may include part(s) located in service vehicles and/or located at central storage(s). The digital service module may comprise a data analytics system that is configured to derive service event(s) from the request for service. The service event(s) may include any one, any combination, or all of: the services needed to fix the problem of the agricultural working machine; the needed service technician(s); the needed tools; and the needed spare part(s). The digital service module may further comprise any one, any combination, or all of: a route management system configured to plan and/or implement the routes of transport devices for transporting any one, any combination, or all of the spare part(s), the tool(s), and service technician(s); a spare parts management system configured to plan and/or implement the availability of the spare part(s) in parts storage device(s) (e.g., warehouses); and a technician management system configured to plan and/or implement the availability of service technician(s). The digital service module may further comprise a central management system configured to coordinate any one, any combination, or all of: the route management system; the spare parts management system; and the technician management system, with the planning and implementing the service events based on a strategy (such as an optimization strategy). The strategy (such as the optimization strategy) may be a multi-target optimization strategy based on a number of weighted criteria (such as optimization criteria), wherein the criteria (such as the optimization criteria) at least including any one, any combination, or all of:

reduce (such as minimize) reaction time between service request and starting time of the service event (e.g., the starting time for performing the service event); reduce (such as minimize) costs for the service event; increase (such as maximize) quality level of the service; and reduce (such as minimize) waiting time of the service technician for spare part(s) at the agricultural working machine.

In one or some embodiments, the central management system coordinates any combination or all of the route management system, the spare parts management system and the technician management system by realizing an information cycle, which may be followed by an optimizing cycle and an implementation cycle. In one or some embodiments, the central management system may switch from the implementation cycle back to the optimizing cycle responsive to automatically determining that the real implementation does not meet the optimization criteria defined in the optimization strategy. This may lead to an ongoing automatic optimization even during the implementation with accordingly good optimization results.

In one or some embodiments, the optimization strategy may also be directed to previously-planned service events, which may be being automatically implemented or which are to be automatically implemented. This may ensure that fewer or no time schedule collisions between service events occur and that possible synergies between similar service events may be being effectively used.

In one or some embodiments, any one, any combination, or all of the route management system, the spare parts management system and the technician management system, on implementation request, may each automatically perform detailed planning cycles. This may mean that the central management system may provide the basic guideline for implementation with its implementation requests, while the subsystems, on this basis, may automatically perform the detailed planning. This automatic centralized rough planning and decentralized automatic fine planning may lead to an exceptionally effective planning process.

For providing a technical service as noted above, the customer may be provided with a realistic time estimation until the starting time of the service event and may take one or more actions necessary to keep this promise to the customer without delay.

In one or some embodiments, an urgency level for the service event may be derived by the central management system from the information about the agricultural process, which may be stored in the database. This may mean that changes in the agricultural process, for example changes in the agricultural working machine and/or changes in weather and/or changes within the harvest may automatically lead to a change of the urgency level, which may be one of the optimization criteria.

In one or some embodiments, the optimization criteria may be weighted. Specifically, at least one change, such as a change in the agricultural process, may lead to a change in the weighting. The optimization may be automatically adapted to the agricultural process with its above-noted dynamics.

In one or some embodiments, the optimization cycle may rely on prediction information. Prediction information may be derived from any one, any combination, or all of: local historical data; global historical data; local live information; and global live information. It may well be that certain local conditions may lead to certain machine defects, which may be automatically predicted based on local historical data. This prediction information may help to further optimize the service event.

In one or some embodiments, the route management system may be central to the realization of the optimization strategy. In particular, changes in the route planning may result in optimization.

Thus, in one or some embodiments, the system is configured to perform any one, any combination, or all of the following:
provide not merely individual machines, parts or services, but an all-inclusive solution to the service problem. In this regard, the system may guarantee that the service problem is solved on time and to the requisite quality;
provide route planning to automatically plan and manage the interaction between service truck(s), part runner(s), required technician(s) and the warehouse(s) of the different categories;
provide qualified personnel that are automatically assigned in the right number so that the service may be accomplished in a quality-oriented manner. This may require that the problem be solved is described or identified in such a way that the appropriate technician or technicians may be selected. It may also play a role so that those specialists are selected who are appropriately qualified and are available as close as possible to the customer so that the service promise within a predetermined time period (e.g., within 30 minutes) may be fulfilled;
ensure that the spare parts are also available, with the system automatically planning and automatically coordinating the management of the spare parts, including automatically assembling the parts stock stored in the respective warehouses in such a way to solve the problems that predominantly arise in a respective region, either by already having the requisite spare parts in stock and/or by automatically organizing their procurement from central warehouses. In one or some embodiments, the system may automatically factor region-specific requirements, such as the cultivation of wear-intensive grain/crop types, when is the harvest, etc. in automatically managing the procurement, storage and/or transportation of the spare parts; or
automatically coordinating the interaction of the service “players” in such a way that the service may be performed on time and to the required quality. In this context, it may also play a role in which plant species are grown in a region, when they will be ready for harvest, which parts are usually available and which qualifications the technicians should have.

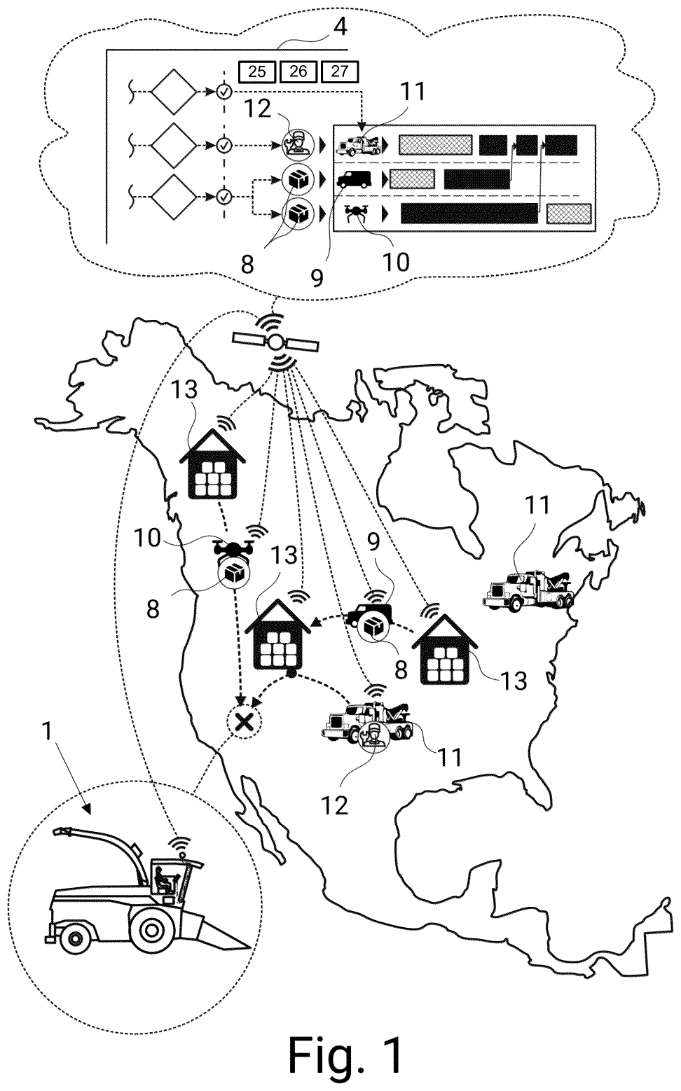

Referring to the figures, FIG. 1 illustrates an example of how an agricultural working machine 1 may be serviced. In FIG. 1, a technical service has been planned for the depicted agricultural working machine 1 marked with an “X”. The technical service may be planned by a digital service module 2, explained in more detail below.

The agricultural working machine 1 may be operated within an agricultural process by a customer 3. The agricultural process may be a variety of types of processes, such as a harvesting process, a soil cultivation process or the like. In the following description, and as an example, the agricultural process is a crop harvesting process, which may be performed by a combine. Other agricultural processes are contemplated.

The digital service module 2 may be hosted on a server 4 with a database 5. The server 4 may comprise computing and communication functionality, such as including at least one processor 25, at least one memory 26, and at least one communication interface 27. The at least one processor 25 and at least one memory 26 may be in communication (e.g., wired and/or wirelessly) with one another. In one or some embodiments, the processor 25 may comprise a microprocessor, controller, PLA, or the like. Similarly, the memory 26 may comprise any type of storage device (e.g., any type of memory). Though the processor 25 and the memory 26 are depicted as separate elements, they may be part of a single machine, which includes a microprocessor (or other type of controller) and a memory. Alternatively, the processor 25 may rely on the memory 26 for all of its memory needs. Still alternatively, the processor 25 may rely on a database (such as database 5) for some or all of its memory needs.

The memory 26 may comprise a tangible computer-readable medium that include software that, when executed by the processor 25 is configured to perform any one, any combination, or all of the functionality described herein, such as one or more parts of the digital service module 2. In this regard, any functionality described herein, such as (without limitation) with regard to the data analytics system 14, the route management system 15, the spare parts management system 16, the technician management system 17, the central management system 18, the drone 10, the service vehicle 11, the prediction management system 21, customer 2 (via a laptop computer, a smartphone, tablet or the like that includes a user interface, such as a touchscreen), or service technician 12 (via a laptop computer, a smartphone, tablet or the like that includes a user interface, such as a touchscreen) may use the computing functionality described herein, such as the processor 25, the memory 26 and/or the communication interface 27.

Further, the communication interface 27 may be configured to communicate (e.g., wired and/or wirelessly) with one or more electronic devices. As one example, any one, any combination, or all of the following may communicate with one another via its respective communication interface 27: agricultural working machine 1; the server 4; customer (via a laptop computer, a smartphone, tablet or the like); part runner 9; drone 10; service vehicle 11; service technician (via a laptop computer, a smartphone, tablet or the like); data analytics system 14; route management system 15; spare parts management system 16; technician management system 17; central management system 18; or the prediction management system 21.

The processor 25 and the memory 26 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The digital service module 2 may be configured to automatically coordinate a technical service for the agricultural working machine 1. Again as an example, the agricultural working machine 1 may have a technical problem, such as due to unusual squeaking sounds from the threshing unit of the combine. Other technical problems are contemplated.

First, the digital service module 2 of the server 4 may receive (such as automatically receive) a request for service 6 during performing the agricultural process (e.g., in preparation for performing, during performing, or thereafter proximate in time to performing the agricultural process). This request may be made by the customer 3, for example via a customer support 7, or by the agricultural working machine 1 itself via a communication module. In one or some embodiments, all communication amongst different devices may be internet-based, for example.

In one or some embodiments, the request for service 6 is actually being made during the agricultural process. This may be, depending on the machine problem, while the agricultural working machine 1 is still running. The request for service 6 may include a problem description regarding a technical problem of the agricultural working machine 1. This problem description may include explicitly the service event to be performed including the necessary resources for fixing the problem. Alternatively, or in addition, the problem description may include a description of the machine problem in natural language, for example: “The threshing unit produces squeaking sounds”.

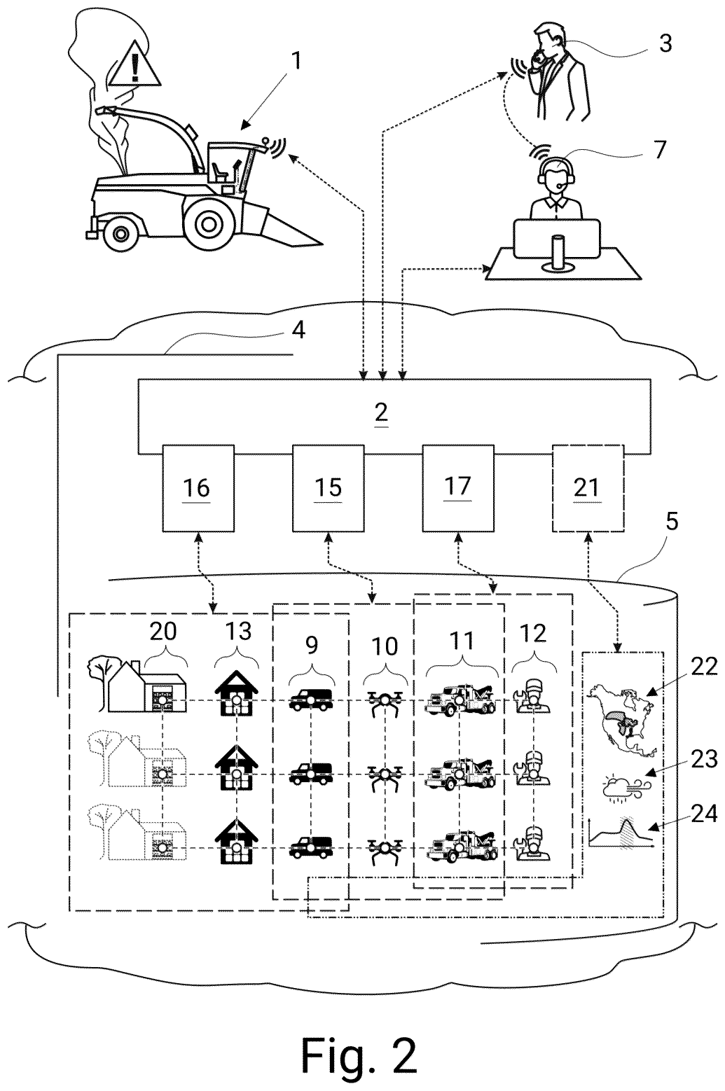

As noted above and shown in FIG. 2, the server 4 comprises a database 5. The database 5 may have stored therein information about any one, any combination, or all of: the agricultural process; the location of the agricultural working machine 1; locations of spare parts 8 for the agricultural working machine 1; information about transport devices (such as part runners 9 or drones 10) for the transport of parts; service vehicles 11 comprising tools for servicing the agricultural working machine 1; and information about service technicians 12.

In one or some embodiments, the transport device may comprise autonomous transport devices which may autonomously transport the parts, one example of which may comprise drones 10, another example of which may comprise autonomous vehicles or self-driving vehicles that act as part runners 9. In one or some embodiments, service vehicles may likewise comprise autonomous transport devices (e.g., autonomous vehicles or self-driving vehicles) that may include the tools for servicing the agricultural working machine. Alternatively, or in addition, the service technicians may be transported via autonomous transport devices (e.g., autonomous vehicles or self-driving vehicles). As such, in one or some embodiments, the route management system of the digital service module may automatically generate one or more routes for any one, any combination, or all of the transport device(s) for transporting the one or more spare parts, the transport device(s) for transporting the one or more tools, or the transport device(s) for transporting the one or more service technicians, with any one or more of the transport device(s) being autonomous transport devices (e.g., autonomous vehicles or self-driving vehicles).

The information about the agricultural process may include: information regarding the harvest, the crop, the soil or the like; and/or technical information about the agricultural working machine 1; and/or weather information. A typical information about the agricultural process may be any one, any combination, or all of: the work progress with regard to the harvest of a field; the change of the characteristic of the agricultural working machine 1 (which in the example may be the increase of the squeaking noise); or weather information (such as an approaching front carrying rain).

Often, a problem of the agricultural working machine 1 may require the exchange of spare parts 8 like a belt, a valve, a hydraulic pump, electronic components or the like. Those spare parts 8 may be located in any one, any combination, or all of: service vehicles 11; at central storage(s) 13; or the like.

The digital service module 2 may comprise a data analytics system 14 automatically deriving service events from the request for service 6. Those service events may include any one, any combination, or all of: the services needed to fix the problem of the agricultural working machine 1; the needed service technician 12; the needed tools; and the needed spare parts 8. In one or some embodiments, the data analytics system 14 comprises a simple rule-based system configured to extract the information about the necessary service event from the request for service 6. Alternatively, the data analytics system 14 may comprise a more sophisticated, AI-based system, that is trained to process natural language input. As a result, a service event, which is to be performed at the agricultural working machine 1, may be defined to include any one, any combination, or all of: the services needed to fix the problem of the agricultural working machine 1; the needed service technician 12; the needed tools; and the needed spare parts 8 as noted above.

In one or some embodiments, the disclosed system and method are configured to make sure that some or all resources for the service event are present within a predetermined amount of time at the agricultural working machine 1. In order to achieve this task, the digital service module 2 may comprise any one, any combination, or all of:

a route management system 15 configured to automatically plan and automatically implement the routes of transport device(s) for transporting any one, any combination, or all of: spare parts 8; tools; and service technicians 12;
a spare parts management system 16 configured to automatically plan and automatically implement the availability of the spare parts 8 in parts storage devices such as warehouses; and
a technician management system 17 configured to automatically plan and automatically implement the availability of service technicians 12.

In other words, the complex task of providing all those resources from different locations to the agricultural working machine 1 within a predefined timescale, may be automatically performed at least partially de-centrally by the route management system 15, the spare parts management system 16, and the technician management system 17.

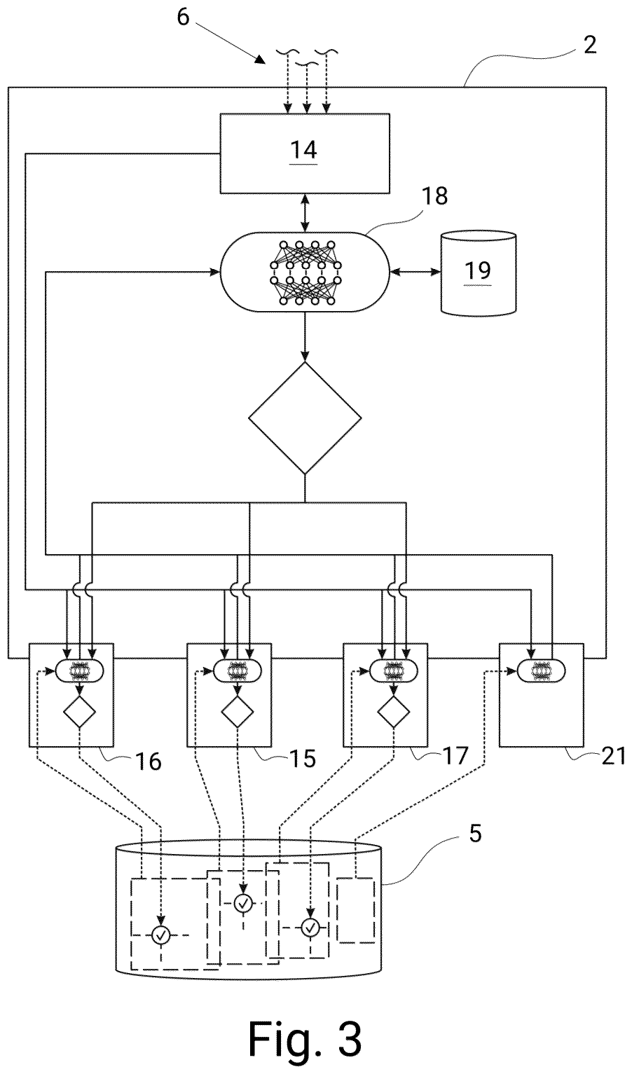

In one or some embodiments, the digital service module 2 may further comprise a central management system 18 configured to automatically coordinate one or more subsystems, such as any one, any combination, or all of: the route management system 15; the spare parts management system 16; and the technician management system 17 for planning and implementing the service events based on an optimization strategy. This is indicated in FIG. 2 and FIG. 3.

In one or some embodiments, the optimization strategy may comprise a multi-target optimization strategy based on a number of weighted optimization criteria 19, wherein the optimization criteria 19 at least include any one, any combination, or all of:

reduce (or minimize) reaction time between service request and starting time of the service event; reduce (or minimize) costs for the service event; increase (or maximize) quality level of the service; or reduce (or minimize) waiting time of the service technician 12 for spare parts 8 at the agricultural working machine 1.

Other optimization criteria 19 are contemplated. In one or some embodiments, the optimization criteria 19 may be dynamically and automatically changed at least partly during the implementation of the service event, for example, responsive to automatically determining that one or more aspects of the agricultural process have changed (such as changed more than a predetermined amount). This may, for example, be a weather change (e.g., responsive to automatically determining that the temperature has increased greater than a predetermined number of degrees or decreased greater than a predetermined number of degrees). Responsive to this automatic determination that one or more aspects of the agricultural process have changed, one or more aspects of the optimization may be changed, such as either the optimization criteria itself being used and/or the weighting or priority of the optimization, such as making the optimization criteria 19 “minimize reaction time between service request and starting time of the service event the top priority, while the optimization criteria 19 “Minimize costs for the service event” being a lower priority.

The optimization criteria 19 “Maximize quality level of the service” may comprise an interesting aspect: The situation may appear that there may be at least two alternatives to fix the problem of the agricultural working machine 1. One alternative may be the high (or a higher) quality, standard exchange of a spare part 8. In the present example, this may be the exchange of a belt of the threshing unit. The other alternative may be the repair of the existing part, such as trying to repair the belt, which may only be a preliminary solution and which may be considered a low (or a lower) quality solution. However, responsive to automatically determining that the agricultural process is almost finished (e.g., an automatic determination that the field subject to plowing is nearly entirely plowed), the optimization criteria 19 “Maximize quality level of the service” may be of low priority in favor of the optimization criteria 19 “Minimize reaction time between service request and starting time of the service event”. Here, it may become clear that the optimization based on a multi-target optimization strategy may be advantageous for meeting the needs of the agricultural process. Further, in this regard, the automatic dynamic or real-time determination of at least one aspect of the agricultural process (e.g., the amount of completion of the agricultural process and/or changed conditions (such as changed weather conditions)), may result in an automatic updating of the optimization, such as the automatically updated coordination of the one or more subsystems, such as any one, any combination, or all of: the route management system 15; the spare parts management system 16; and the technician management system 17 for planning and implementing the service events based on the updated optimization strategy.

An exemplary sequence of events is illustrated in FIG. 3. After receiving the request for service 6, the central management system 18 may automatically coordinate the route management system 15, the spare parts management system 16 and the technician management system 17 based on the optimization strategy.

As a first step, this may be automatically done by the central management system 18 in an information cycle, automatically sending information requests to the technician management system 17, the spare parts management system 16 and the route management system 15 to automatically retrieve information about any one, any combination, or al of: the locations and availability of instances of the needed service technician 12; the needed tools; or the needed spare parts 8; and to automatically retrieve information about possible routes for transport devices to directly or indirectly transport any one, any combination, or all of the needed service technician 12, the needed tools, or the needed spare parts 8 to the location of the service event. Thus, the route management system 15 may be configured to perform one or both of: automatically generating a map that includes the one or more routes for one or more of: transporting one or more of the spare parts, the tools or the service technicians; or automatically transporting one or more of the spare parts, the tools, or the service technicians (such as using a driverless vehicle or an automated drone that automatically transports the spare parts or tools).

In one or some embodiments, the expressions “service technician” 12, “tools”, “spare parts” and “transport devices” may represent not the actual existing component, but the type of component. An “instance” of the respective component, however, may represent the actual existing component. If, for example, the central management system 18 automatically derives that the service event requires a belt as a spare part 8, then this may mean just the type of the spare part 8, namely a belt with a certain product number. The instance of the belt, however, may be the belt actually being present in a storage device, such as a central storage 13 or even within a service vehicle 11.

Subsequently, the central management system 18 may automatically perform an optimization cycle based on the optimization strategy, in which the central management system 18 may automatically identify the respective instances and desired relocation requirements for at least part of those instances and the resulting routes for transportation devices and automatically generate a time schedule for the implementation. It may well be that the instances of all resources needed are available and stored in a convenient location. Statistically, however, there is a probability that, for example, the instance of a needed spare part 8 is not available nearby the agricultural working machine 1 in a central storage 13 or warehouse or at a local stock at farm 20, such that a relocation of the spare part 8 has to be automatically initiated. For this, the central management system 18 automatically plans the relocation of the respective resource.

Based on the results of the optimization cycle, in an implementation cycle, the central management system 18 may automatically forward implementation requests including any one, any combination, or all of the identified instances, routes for transportation devices and a time schedule to any one, any combination, or all of the technician management system 17, the spare parts management system 16, or the route management system 15. In this way, the repair service, automatically coordinating each of the spare part(s), the needed tool(s), the service vehicle(s), and the needed technician(s) may be located at a respective time or within a respective time window (e.g., within a predetermined period, such as a 30-minute period).

Finally, based on the implementation tasks, any one, any combination, or all of the technician management system 17, the spare parts management system 16 and the route management system 15 automatically implementing the time schedule by automatically sending execution requests to the instances of the needed service technician 12, of the needed tools, of the parts storage devices and to the transport devices assigned to the identified routes. In the course of this implementation, the subsystems may automatically perform a decentralized planning of the implementation request. This may include the communication automatically sent between the subsystems in order to further optimize the sequence of actions regarding the above noted optimization strategy. For example, this may apply to the route management system 15, which may automatically coordinate the transport of all resources and may automatically and iteratively generate and assess route alternatives in view of the optimization strategy (including responsive to the automatic updating of the optimization strategy, as discussed above). In particular, the route management system 15 may implement the one or more routes by automatically loading the one or more routes into one or more devices, such as automatically loading the one or more routes into any one, any combination, or all of: the electronic device(s) associated with the service technicians; the electronic device(s) associated with the vehicle for the service technicians (e.g., automatically load the route(s) into the navigation system of the vehicle for the service technician); the electronic device(s) associated with the transport device(s) (e.g., into the navigation system of the service vehicle(s)); automatically load the route into a driverless vehicle or drone; etc.

In one or some embodiments, the optimization strategy may comprise the automatic coordination of the service event with prior service events, that are being implemented or that will be implemented, such that time schedule collisions are automatically prevented and that redundant routes are automatically combined. Again, the optimization strategy may be taken into account, automatically prioritizing one service event over another service event.

As noted above, after the optimization cycle, the technician management system 17, the spare parts management system 16 and the route management system 15, for the implementation of the implementation tasks, may each automatically perform detailed planning cycles. These detailed automatic planning cycles may be independent from each other. In order to allow the subsystems to effectively contribute to an optimized result, the subsystems may be given a predetermined freedom to automatically deviate from the respective implementation request, taking into account the optimization strategy.

As also noted above, the service events may be automatically managed with respect to time. In one or some embodiments, the route management system 15 may automatically generate an estimation of the starting time for the service event at the agricultural working machine 1, that the central management system 18 automatically forwards this planned estimated starting time to the customer 3 and that another optimization criteria 19 for the optimization strategy is “Minimizing the delay of the starting time for the service event with respect to the planned starting time”. This may mean that any deviation from the planned starting time is to be prevented. This additional optimization criteria 19 may be considered a high or low priority depending on the optimization strategy.

For the effective planning of the service event, it is proposed to realize an indication for the urgency for having the machine problem solved. Therefore, the central management system 18 may automatically derive an urgency indication from the customer 3 and/or from the information about the agricultural process stored in the database 5, for example depending on increasing wear of other aggregates of the agricultural machine induced by the problem to be solved by the service event. As another optimization criteria 19, the urgency lever, either manually set by the customer 3 or automatically set from within the agricultural process, may be defined. In the latter case, rules may be stored in the central management system 18 in order to automatically derive the respective urgency level.

In one or some embodiments, each optimization criteria 19 may be automatically weighted within the optimization strategy such that each optimization criteria 19 is assigned a priority value, which may be automatically changed in the course of the implementation of the service event responsive to a customer 3 request and/or responsive to automatically identifying a change of the agricultural process. The change of the agricultural process may be any change that may increase or decrease the urgency to solve the machine problem. Based on this priority value for each optimization criteria 19, the multi target optimization strategy may be executed.

In one or some embodiments, a prediction information may be automatically derived by a prediction management system 21 shown in FIG. 2. The prediction management system 21 may automatically generate prediction information regarding any one, any combination, or all of regional cultivation and harvesting characteristics, regional climate/weather characteristics, and/or regional soil characteristics and/or regional technical failure expectations based on any one, any combination, or all of regional data 22, weather data 23 and seasonal data 24 in combination with local and global live information. In one or some embodiments, the prediction information may be automatically taken into account during the optimization cycle. This is interesting, as all this information may help to manage the service event. For example, the cultivation and harvesting information may include information about the usual kind of crop being cultivated and the usual time of harvest during the year, which information may be used during optimization cycle, even if this information has not been forwarded by the customer 3. The usual weather characteristics may again be regarded in the optimization cycle, in order to estimate whether minimizing the time needed to fix the machine problem is of higher or lower priority.

In one or some embodiments, the route management system 15, on implementation task, automatically generates routes of transport devices to orchestrate the transport of instances of needed service technicians 12 and needed spare parts 8 to the agricultural working machine 1 to be serviced and automatically transmitting requests for execution to the respective transport devices, taking into account at least the optimization criteria 19 including one or both of:

reduce (or minimize) reaction time between service request and starting time of the service event; or reduce (or minimize) waiting time of the service technician 12 for spare parts 8 at the agricultural working machine 1.

Especially regarding the execution of routes by transport devices, numerous influences may be present to compromise meeting the time schedule. In this regard, the route management system 15 may automatically monitor the actual execution of the routes of transport devices and may automatically identify deviations from the time schedule, and depending on the degree of deviation automatically perform (e.g., comparing the degree of deviation with a predetermined amount; responsive to determining that the degree of deviation is greater than or equal to the predetermined amount, automatically perform) one or both of:
modifies the routes to meet the time schedule and transmits a request for execution of the new routes by the respective transport devices; or
sending a change request to the central management system 18 to perform an automatic optimization cycle to automatically generate a new implementation request.

The spare parts management system 16 may be responsible for the automatic availability of any spare parts 8 needed for performing the service event. As one example, the spare parts management system 16 may automatically request and/or implement routing of the parts to the central storage or the service vehicles. Thus, in one or some embodiments, the spare parts management system 16 is configured to perform any one, any combination, or all of: (i) automatically generating an output on a screen at a designated time (e.g., a time selected based on the designated time to service the agricultural vehicle) requesting an operator to approve the order of the spare part that needed to fix the technical problem; (ii) automatically ordering the spare part by automatically sending a communication in order to route the spare part to the location of the agricultural machine or of the service vehicle; or (iii) at least partly automatically transporting the spare parts to the location of the agricultural machine or of the service vehicle (e.g., drone delivery; automatic loading of the spare part into a respective service vehicle of the technician; or automatic identifying of the spare part in order for a person to place the spare part into a respective service vehicle of the technician). In this regard, the spare parts management system 16 may generate an automatic request or automatic routing of the spare part(s) to the central storage, to the service vehicles, or to the location of the agricultural machine.

In particular, in one or some embodiments, the spare parts management system 16 is configured to automatically perform any one, any combination, or all of:

automatically monitors the locations and availability of instances of spare parts 8 and introduces this information into the database 5; automatically organizes a predetermined inventory of spare parts 8 in storage devices such as central storages 13 by transmitting transport requests to the route management system 15; on an implementation request by the central management system 18, automatically organizes the availability of certain instances of spare parts 8 by transmitting a transport request to the route management system 15; or on an implementation request by the central management system 18, automatically organizes a handover of certain instances of spare parts 8 at a certain location.

The technician management system 17 may be responsible for the automatic availability of service technicians 12 and their respective qualification. For example, the technician management system 17 may automatically generate one or more requests of the service technicians, such as any one, any combination, or all of automatically generating a schedule for the service technicians, automatically sending notices of the schedule to the technicians, or automatically populating calendars (or the like) for the service technicians with the scheduled appointment. In this regard, the technician management system 17 may automatically populate the calendar of a service technician and/or send an electronic message (e.g., an email and/or a text message) to the service technician to perform the service call. Thus, in one or some embodiments, the technician management system 17 is configured to automatically perform any one, any combination, or all of:
automatically monitors the locations and availability of instances of service technicians 12 and the respective qualification and introduces this information into the database 5; automatically organizes a predetermined distribution of qualification of service technicians 12 by transmitting transport requests to the route management system 15 and/or to the instance of the service technician 12; or on an implementation request by the central management system 18, automatically organizes the availability of certain instances of service technicians 12 by transmitting a transport request to the route management system 15 and/or to the instance of the service technician 12.

According to the above, various communication and data exchange may automatically take place between any one, any combination, or all of the customer 3, the service technicians 12, the digital service module 2 the transport devices, the storage devices and the agricultural working machine 1, as is indicated in the drawings. For this, those entities may be assigned respective communication interfaces.

Moreover, the agricultural working machine 1 may be provided with sensors configured to detect the state of the machine and/or the respective mode of operation. This information may be automatically retrieved by the digital service module 2, as noted above. The same may apply to the transport devices and the storage devices. The customer 3 and the service technicians 12 may be assigned communication devices such as mobile phones.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 agricultural working machine
2 digital service module
3 customer
4 server
5 database
6 request for service
7 customer support
8 spare part
9 part runner
10 drone
11 service vehicle
12 service technician
13 central storage
14 data analytics system
15 route management system
16 spare parts management system
17 technician management system
18 central management system
19 optimization criteria
20 local stock at farm
21 prediction management system
22 regional data
23 weather data
24 seasonal data
25 processor
26 memory
27 communication interface

1. A computer-implemented method for providing technical service to an agricultural working machine, wherein the agricultural working machine operates an agricultural process by a customer, the method comprising:
receiving, by a digital service module of a server for coordinating the technical service, a request for service at least partly during performing the agricultural process, the request for service including a problem description regarding a technical problem of the agricultural working machine;
automatically accessing a database, wherein the database comprises information about the agricultural process, location of the agricultural working machine, one or more locations of spare parts for the agricultural working machine, information about one or more transport devices for transport of parts, information about one or more service vehicles comprising tools for servicing the agricultural working machine, and information about one or more service technicians, wherein the parts are located in the one or more service vehicles or at one or more central storages;
automatically deriving, using a data analytics system of the digital service module and based on the request for service, at least one service event, wherein the at least one service event includes one or more services in order to fix the technical problem of the agricultural working machine, one or more service technicians to fix the technical problem, one or more tools used by the one or more service technicians to fix the technical problem, and one or more spare parts used by the one or more service technicians to fix the technical problem;
automatically generating and implementing, using a route management system of the digital service module, one or more routes of one or more transport devices for transporting the one or more spare parts, the one or more tools and the one or more service technicians;
automatically planning and implementing, using a spare parts management system of the digital service module, availability of the one or more spare parts in at least one central storage or in the one or more service vehicles;
automatically planning and implementing, using a technician management system of the digital service module, availability of the one or more service technicians; and
automatically coordinating, using a central management system of the digital service module, the route management system, the spare parts management system and the technician management system for planning and implementing the at least one service event based on a strategy, wherein the strategy comprises a multi-target strategy based on a plurality of weighted criteria, wherein the plurality of weighted criteria at least include:
reduce reaction time between the request for service and starting time in performing the at least one service event;
reduce costs for the at least one service event;
increase quality level in performing the at least one service event; and
reduce waiting time of the one or more service technician for one or more spare parts at the agricultural working machine.

2. The method of claim 1, wherein the route management system is configured to perform one or both of:
automatically generating a map that includes the one or more routes for one or more of: transporting one or more of the spare parts, the tools or the service technicians; or
automatically transporting one or more of the spare parts, the tools, or the service technicians.

3. The method of claim 1, wherein the spare parts management system performs one or more of: (i) automatically generating an output on a screen at a designated time requesting an operator to approve the order of the spare part that needed to fix the technical problem; (ii) automatically ordering the spare part by automatically sending a communication in order to route the spare part to the location of the agricultural working machine or of the service vehicle; or (iii) at least partly automatically transporting the spare parts to the location of the agricultural working machine or of the service vehicle.

4. The method of claim 1, wherein the technician management system performs one or more of: automatically populating a calendar of the service technician; or sends an electronic message to the service technician to perform the service call.

5. The method of claim 1, wherein the strategy comprises a multi-target optimization strategy based on a plurality of weighted optimization criteria; and
wherein the plurality of weighted optimization criteria at least include:
minimize the reaction time between the request for service and the starting time in performing the at least one service event;
minimize the costs for the at least one service event;
maximize the quality level in performing the at least one service event; and
minimize the waiting time of the one or more service technician for one or more spare parts at the agricultural working machine.

6. The method of claim 1, wherein the one or more transport devices comprise part runners.

7. The method of claim 1, wherein, after receipt of the request for service, the central management system coordinates the route management system, the spare parts management system and the technician management system based on an optimization strategy, by:
in an information cycle, automatically sending one or more information requests to the technician management system, the spare parts management system and the route management system to retrieve the information regarding: locations and availability of the one or more service technicians; the one or more tools to fix the technical problem; the one or more spare parts to fix the technical problem; and potential routes for transport devices to directly or indirectly transport instances to the location of the service event;
in an optimization cycle based on the optimization strategy, identifying the respective instances and desired relocation requirements for at least part of the instances and resulting routes for transportation devices and generating a time schedule for the implementation;
in an implementation cycle, forwarding implementation requests including the instances that are identified, routes for transportation devices and a time schedule to the technician management system, the spare parts management system and the route management system; and
based on the implementation requests, the technician management system, the spare parts management system and the route management system implement the time schedule by sending execution requests to the instances of needed service technician, of needed tools, of parts storage devices and to the transport devices assigned to the routes.

8. The method of claim 1, wherein an optimization strategy comprises coordination of the service event with other service events, that are being implemented or that will be implemented, such that time schedule collisions are prevented and that redundant routes are combined.

9. The method of claim 1, wherein, after an optimization cycle, the technician management system, the spare parts management system and the route management system, for the implementation of one or more implementation requests, each perform detailed planning cycles with a predetermined freedom to deviate from the one or more implementation requests, taking into account an optimization strategy.

10. The method of claim 1, wherein the route management system generates an estimation of the starting time for the service event at the agricultural working machine;
wherein the central management system forwards the estimation of the starting time to the customer;
wherein the strategy comprises an optimization strategy; and
wherein at least one optimization criterium for the optimization strategy is minimizing delay of the starting time for the service event with respect to a planned starting time.

11. The method of claim 1, wherein the central management system derives an urgency indication from one or both of the customer or the information about the agricultural process stored in the database;
wherein the strategy comprises an optimization strategy; and
wherein optimization criteria for the optimization strategy are: urgency level set by the customer; and urgency level set from within the agricultural process.

12. The method of claim 11, wherein the urgency indication is dependent on increasing wear of other aggregates of the agricultural working machine induced by the technical problem to be fixed by the service event.

13. The method of claim 1, wherein the strategy comprises an optimization strategy; and
wherein each optimization criteria is weighted within the optimization strategy such that each optimization criteria is assigned a priority value, which is changed in implementation of the service event based on one or both of a customer request or a change of the agricultural process.

14. The method of claim 1, wherein the digital service module further comprises a prediction management system that generates prediction information regarding one or more of: regional cultivation and harvesting characteristics; regional climate/weather characteristics; or regional soil characteristics and/or regional technical failure expectations based on regional data, weather data and seasonal data in combination with local and global live information and that the prediction information is taken into account during an optimization cycle.

15. The method of claim 1, wherein the route management system, responsive to receiving one or more implementation requests, automatically generates one or more routes of transport devices to orchestrate the transport of instances of needed service technicians and needed spare parts to the agricultural working machine to be serviced and transmits at least a part of the one or more implementation requests for execution to the respective transport devices, taking into account at least the plurality of weighted criteria including one or both of: reduction in reaction time between service request and starting time of the service event; or reduction in waiting time of the service technician for spare parts at the agricultural working machine.

16. The method of claim 1, wherein the route management system automatically and dynamically monitors actual execution of the routes of transport devices and automatically identifies one or more deviations from a time schedule; and
responsive to the one or more deviations being greater than or equal to a predetermined amount, performing one or both of:
modifying the routes of the transport devices to meet the time schedule and transmitting, to the transport devices, a request for execution of the routes that are modified; or
sending a change request to the central management system to perform an optimization cycle to generate a new implementation request.

17. The method of claim 1, wherein the spare parts management system performs one or more of:
monitors the locations and availability of the spare parts and saves the locations and the availability into the database;
organizes a predetermined inventory of spare parts in one or more warehouses by transmitting transport requests to the route management system;
responsive to an implementation request by the central management system, organizes the availability of respective spare parts by transmitting a transport request to the route management system; or
responsive to the implementation request by the central management system, organizes a handover of one or more instances of the spare parts at a predetermined location.

18. The method of claim 1, wherein the spare parts management system performs each of:
monitors the locations and availability of the spare parts and saves the locations and the availability into the database;
organizes a predetermined inventory of spare parts in one or more warehouses by transmitting transport requests to the route management system;
responsive to an implementation request by the central management system, organizes the availability of respective spare parts by transmitting a transport request to the route management system; and
responsive to the implementation request by the central management system, organizes a handover of one or more instances of the spare parts at a predetermined location.

19. The method of claim 1, wherein the technician management system performs one or more of:
monitors locations and the availability of service technicians and respective qualification and saves the locations, the availability and the respective qualification into the database;
organizes a predetermined distribution of qualification of service technicians by transmitting one or more transport requests to one or both of the route management system or to a respective service technician;
responsive to an implementation request by the central management system, automatically organizes the availability of respective service technicians by transmitting a transport request to one or both of the route management system or to the respective service technician.
